(19) United States
(12) Patent Application Publication
(10) Pub. No.: US 2006/0097466 A1
(43) Pub. Date: May 11, 2006

(54) Bodyboard/snowboard

(75) Inventor: Ta-Wei Chi, Taipei, TW (US)

Correspondence Address: TROXELL LAW OFFICE PLLC;SUITE 1404, 5205 LEESBURG PIKE, FALLS CHURCH, VA, 22041, US

(73) Assignee: JACKEL (Far East) Co., Ltd.

(21) Appl. No.: 10/981,496

(22) Filed: Nov. 5, 2004

(51) Int. Cl. B62B 13/00

(52) U.S. Cl. 280/18

(57) ABSTRACT

A bodyboard/snowboard includes a bag, an inner chamber and a protection layer. The bag has an opening thereon and the inner chamber has an air valve thereon. The inner chamber can be inserted in the bag from the opening. By inflating air from the air valve, the inner chamber will be puff up till it integrally fills up the bag for using. By deflating the inner chamber from the air valve to be empty, the inner chamber's bulk will be lessened in order for rolling. Therefore, the bodyboard/snowboard is easily to carry and store. Furthermore, the protection layer can extend the available life and strengthen the surface contacting with outer force. Consequently, the bodyboard/snowboard can be used when surfing or skiing.

### BACKGROUND OF THE INVENTION

1. Field of the Invention

The present invention relates to a guiding board, and particularly to a easily store and portable bodyboard/snowboard, which is formed through inflating air for surfing or skiing.

2. Prior Art

As is well know, sport is the best way to stay health and release pressure. Nowadays, people place an emphasis on the importance of sport much more than ever before. A good sport should have the function of burning caloric and should be exposed to the nature while exercising. Surfing or skiing is a kind of outdoor sport and is quite popular among young people. Accordingly, there are various buoyant panels or bodyboard/snowboards for supporting a person as the board glides come out, which are generally classified as standing type and groveling type.

The conventional bodyboard/snowboards are generally made of PE (Polyethylene Resins) ` EVA (Ethylene Linyl Acetate) ` Polyethylene ` Glass fiber and Carbon Fiber and etc. Although the conventional bodyboard/snowboard is able to surf or ski, but because of its rigid shape, it is not easy to store and to portable. Furthermore, most beach are located in the suburbs, therefore, surfers usually have to go by vehicles and have to take trouble to arrange a quite big space for putting the bodyboard/snowboard or tie up it on the top of the car, which is not convenient and waste too much time on the preparation and may cause the occurrence of an accident while driving.

### SUMMARY OF THE INVENTION

Accordingly, an object of the present invention is to provide a bodyboard/snowboard, which is easily to carry and to store.

Further object of the present invention is to provide a bodyboard/snowboard which can be used as surfing or skiing and extend its available life and strengthen the surface contacting with outer force by the assembly with the protection layer.

To achieve the above-mentioned objects, a bodyboard/snowboard in accordance with the present invention includes a bag, an inner chamber and a protection layer. The bag has an opening thereon and the inner chamber has an air valve thereon. The inner chamber can be inserted in the bag from the opening. By inflating air from the air valve, the inner chamber will be puff up till it integrally fills up the bag for using. By deflating the inner chamber from the air valve to be empty, the inner chamber's bulk will be lessened for rolling. Consequently, the bodyboard/snowboard is easily to carry and store.

Other objects, advantages and novel features of the present invention will be drawn from the following detailed embodiment of the present invention when taken in conjunction with the accompanying drawings.

### BRIEF DESCRIPTION OF THE DRAWINGS

FIG. 1 is an exploded view of a bodyboard/snowboard according to the present invention;

FIG. 2 is a perspective view of the bodyboard/snowboard according to the present invention;

FIG. 3 is a side view of the bodyboard/snowboard of the present invention;

FIG. 4 is a bottom view of the bodyboard/snowboard of the present invention;

FIG. 5 is a cross-section view of the bodyboard/snowboard taken along the line 5-5 of FIG. 3;

FIG. 6 is a schematic elevational view showing the bodyboard/snowboard of the present invention, which has been curled;

FIG. 7 is a bottom view of the present invention further attaches a protrusion plate to the protection layer.

### DESCRIPTION OF THE PREFERRED EMBODIMENTS

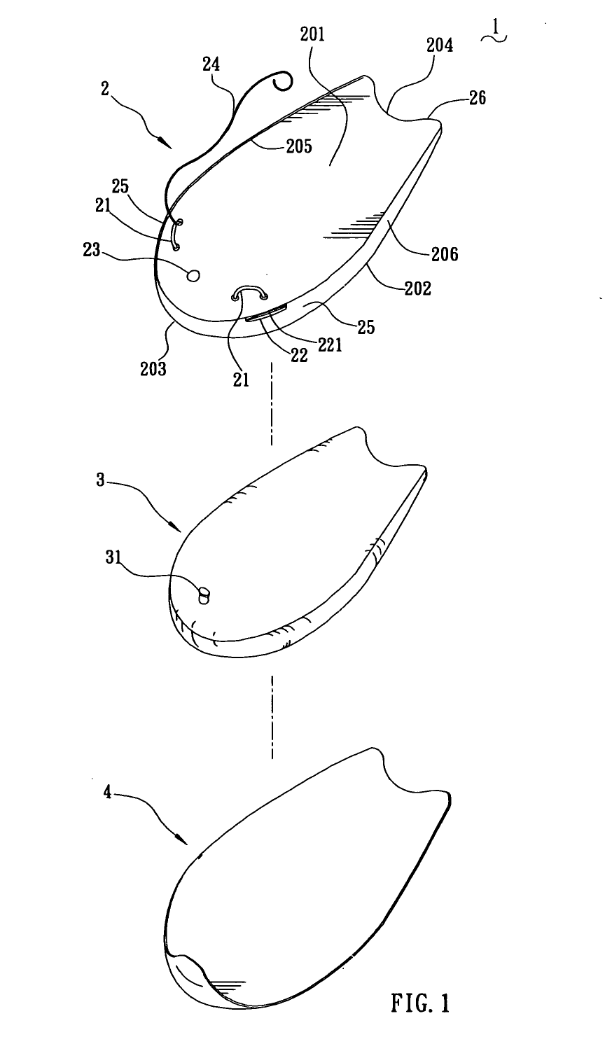

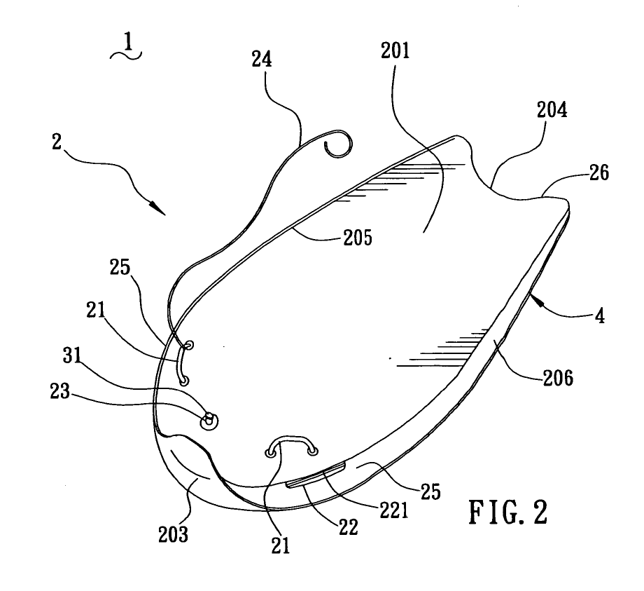

With reference to FIGS. 1 and 2, a bodyboard/snowboard 1 in accordance with the present invention includes a bag 2, an inner chamber 3 and a protection layer 4.

The bag 2 has a first surface 201, a second surface 202, a front end 203, a rear end 204 and a pair of lateral edges 205,206 extending longitudinally between the front end 203 and the rear end 204, wherein the front end 203 is arcuate, and the pair of lateral edges 205,206 are inwardly bent and slightly slant to the front end 203 to become an arcuate portion for reducing the friction causing by surfing, the rear end 204 is inwardly recessed forming a concavity 26 for providing surfers with a more comfortable position when surfing.

The first surface 201 near the front end 203 respectively defined with gripper handle 21 and an engaging hole 23 thereon. The gripper handle 21 is designed for surfers to hold for increasing the stability and steerage, wherein a rope 24 is located thereon for surfers to catch in order to prevent the bodyboard/snowboard 1 from carrying away by the wave. The diameter of the engaging hole 23 is fit with an air valve 31 (describe later) and is adapted for the insertion of the air valve 31. One of the pair of lateral edges 205 defined with an opening 22 thereon being adapted for the insertion of the inner chamber 3 when deflated and has a velcro 221 in the surrounding thereof which is adapted to close and open the opening 22.

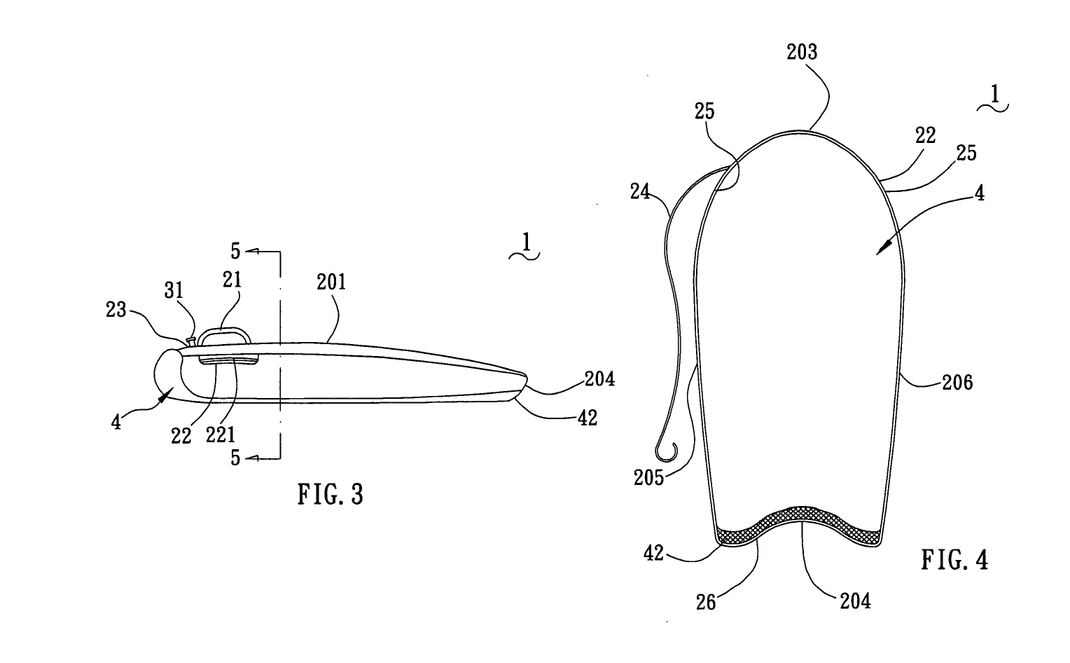

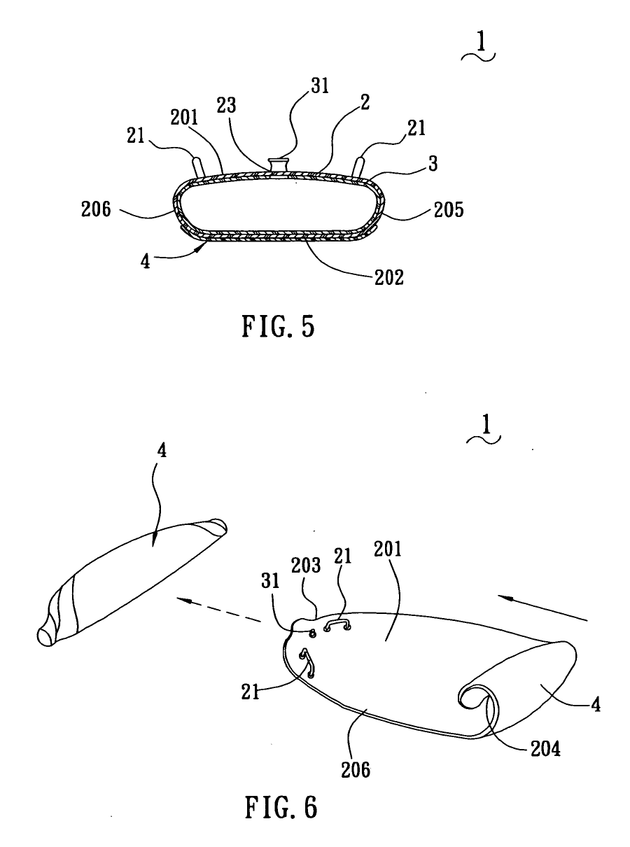

With reference to FIG. 3 to FIG. 5 in combination with FIG. 1-2, the inner chamber 3 made of a tensile and contractible synthetic material having a shape corresponding to the bag 2 being removably insertable in the bag 2 when deflated and being integrally fill up the bag 2 when inflated, and having an air valve 31 thereon in communication with the inner chamber 3 for inflating air and deflating air.

The protection layer 4 made of a rigid material, integrally assembled with the second surface 202 of the bag 2 having a shape corresponding to the second surface 202 and a draining net 42 is attached to one side of the protection layer 4 corresponding to the rear end 204 of the bag 2 and is connected to the rear end 204 for draining water therein.

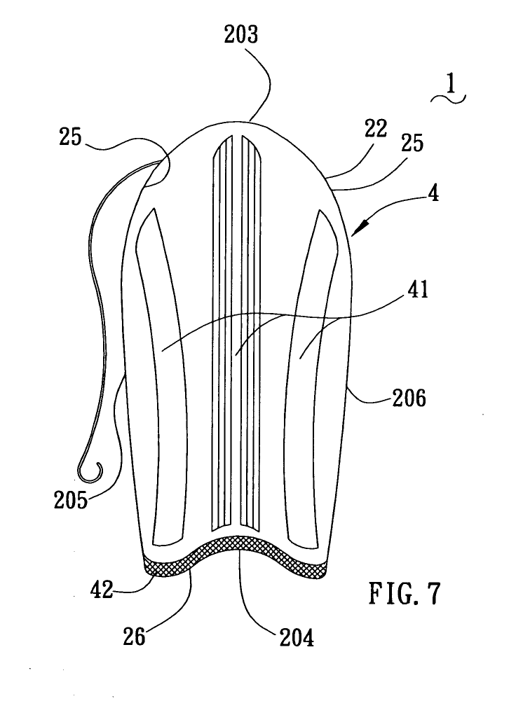

Further referring to FIG. 7, the protection layer 4 further comprises a protrusion plate 41, which protrudes from the protection layer 4 forming a wavy shape for increasing more contact portions in order to enhance the stability and steerage when surfing.

In assembly, rolling the inner chamber 3 in deflated state to a proper width and insert into the opening 22 of the bag 2, pulling out the air valve 31 from the engaging hole 23 then close the opening 22 by the velcro 221 for the bag being sealed. By inflating air from the air valve 31, the inner chamber 3 will be puff up till it integrally fills up the bag 2 for using. By deflating the inner chamber 3 from the air valve 31 to be empty, the inner chamber's 3 bulk will be lessened for rolling in order to easily store and carry. Consequently, the bodyboard/snowboard 1 is easily to carry and save a lot of space for storing; Furthermore, the bodyboard/snowboard 1 of the present invention can extend its available life and strengthen the surface contacting with outer force by the assembly with the protection layer 4. That is, the bodyboard/snowboard 1 of the present invention can be used as surfing or skiing.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. An easily store and portable bodyboard/snowboard adapted for surfing and skiing comprising:
a bag having a first surface, a second surface opposite to the first surface, a front end, a rear end and a pair of lateral edges extending longitudinally between the front end and the rear end; wherein the first surface near the front end respectively defined with gripper handle and an engaging hole thereon and one of lateral edges defined with an opening thereon;
an inner chamber made of a tensile and contractible synthetic material having a shape corresponding to the bag being removably insertable in the bag when deflated and being integrally fill up to the bag when inflated, and have an air valve thereon in communication with the inner chamber; and
a protection layer made of a rigid material, integrally assembled with the second surface of the bag having a shape corresponding to the second surface.

2. The bodyboard/snowboard as claimed in claim 1, wherein the second surface of the bag is flat.

3. The bodyboard/snowboard as claimed in claim 1, wherein the protection layer further comprises a protrusion plate.

4. The bodyboard/snowboard as claimed in claim 3, wherein the protrusion plate protrudes from the second surface forming a wavy shape.

5. The bodyboard/snowboard as claimed in claim 4, wherein the protection layer is made of PE (Polyethylene Resins), ELV (Ethylene Vinyl Acetate Copolymer) and Carbon Fiber and etc.

6. The bodyboard/snowboard as claimed in claim 5, wherein the thickness of the protection layer is within 1.2 mm to 2.0 mm.

7. The bodyboard/snowboard as claimed in claim 6, wherein a draining net is attached to one side of the protection layer corresponding to the rear end of the bag and is connected to the rear end for draining water, which remains between the bag and the inner chamber.

8. The bodyboard/snowboard as claimed in claim 1, wherein the front end of the bag is arcuate, and the pair of lateral edges is bent inward and slight slant to the front end to become an arcuate portion for reducing the friction causing by surfing.

9. The bodyboard/snowboard as claimed in claim 8, wherein the rear end of the bag is inwardly recessed forming a concavity for providing surfers with a more comfortable position when surfing.

10. The bodyboard/snowboard as claimed in claim 9, wherein the opening being adapt for the insertion of the inner chamber when deflated.

11. The bodyboard/snowboard as claimed in claim 10, wherein the opening has a velcro in the surrounding thereof being adapted to close and open the opening.

12. The bodyboard/snowboard as claimed in claim 11, wherein the diameter of the engaging hole is fit with the air valve.

13. The bodyboard/snowboard as claimed in claim 1, wherein the gripper handle has a rope thereon.
